(19) United States
(12) Patent Application Publication
(10) Pub. No.: US 2025/0158442 A1
(43) Pub. Date: May 15, 2025

(54) APPARATUS AND METHOD FOR SUPPLYING POWER TO DEVICE

(71) Applicant: Intel Corporation, Santa Clara, CA (US)

(72) Inventors: Chuen Ming TAN, Bayan Lepas (MY); Venkataramani Gopalakrishnan, Folsom, CA (US); Nirmala Bailur, Bangalore (IN); Tai Loong Wong, Batu Maung (MY); Yi How Ooi, Bayan Lepas (MY); Sze Geat Pang, Gelugor (MY); Wei Cheang Lau, Bayan Lepas (MY); Tod Schiff, Portland, OR (US); Naoki Matsumura, San Jose, CA (US)

(21) Appl. No.: 18/947,143

(22) Filed: Nov. 14, 2024

(30) Foreign Application Priority Data
Nov. 15, 2023 (CN) 202311741750.X

(51) Int. Cl. H02J 7/06; H02J 7/00; H02J 7/34

(52) U.S. Cl. CPC H02J 7/06; H02J 7/0048; H02J 7/342

(57) ABSTRACT

The disclosure provides a device, including: an AC source interface to be coupled to an AC source; a battery interface to be coupled to a battery to be charged by the AC source and discharged for supplying power to the device; and a trigger module to trigger a power supply mode for the device based on a battery-related condition and a device-related condition, wherein the power supply mode includes a reversal power supply mode of using the battery as a primary power source for the device and using the AC source as a secondary power source for the device when the AC source and the battery are both available for providing power to the device.

### TECHNICAL FIELD

Embodiments described herein generally relate to a field of power supply, and more particularly relate to an apparatus and a method for supplying power to a device by using a battery as a primary power source and an alternating current (AC) source as a secondary power source.

### BACKGROUND

For today's mobile devices, two primary power sources available are a battery (e.g., a rechargeable battery) and an AC source connected via a wall adapter. The wall adapter can be an AC adapter or a Type-C/USB-C adapter. When the wall adapter is plugged into the device, the AC source becomes the primary power source for the device while the battery becomes the secondary power source supplementing power when the power demand of the device exceeds the capability of the wall adapter.

### BRIEF DESCRIPTION OF THE DRAWINGS

The various advantages of the embodiments will become apparent to one skilled in the art by reading the following specification and appended claims, and by referencing the following drawings, in which:

FIG. 1 shows example power consumptions under three modes of power supply configuration;

FIG. 2 shows an example “AND” configuration in which both a battery and an AC source are used to provide power to a laptop according to some embodiments of the present application;

FIG. 3 shows an example simulation result illustrating reduction in charger loss contributing to more power available to a System on Chip (SoC) with similar thermal performance (e.g. for a fanless system), according to some embodiments of the present application;

FIG. 4 shows an example schematic structural diagram of a device according to some embodiments of the present application;

FIG. 5 shows an example simplified block diagram of a power supply module for using a battery as a primary power source and using an AC source as a secondary power source to supply power to system load of a device, according to some embodiments of the present application;

FIG. 6 shows an example software solution architecture for a device to implement a power supply mode determined based on an Adaptive Performance Policy, according to some embodiments of the present application;

FIG. 7 shows an example Adaptive Performance Policy configuration to determine a power supply mode for a device, according to some embodiments of the present application;

FIG. 8 shows a flowchart of a proposed method for supplying power to a device, according to some embodiments of the present application;

FIG. 9 is a block diagram illustrating components, according to some example embodiments, able to read instructions from a machine-readable or computer-readable medium and perform any one or more of the methodologies discussed herein; and

FIG. 10 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

For today's mobile devices (e.g., laptop, tablet, mobile phone, etc.), two primary power sources available are a battery (e.g., a rechargeable battery) and an AC source connected via a wall adapter. The wall adapter can be an AC adapter or a Type-C/USB-C adapter. When the wall adapter is plugged into the device, the AC source becomes the primary power source for the device while the battery becomes the secondary power source supplementing power when the power demand of the device exceeds the capability of the wall adapter.

The issue with using the AC source from the wall adapter as the primary power source is the power loss in the Narrow Voltage Direct Conversion (NVDC) stage. The power loss due to the conversion has resulted in additional dissipated heat that may reduce thermal margin and hence degrade performance of the device (e.g., degrading the performance of CPU of the device). According to some embodiments of the present application, it may be possible to significantly reduce the power loss due to the NVDC conversion by using the battery as the primary power source and using the AC as the secondary power source, especially for the device operating in a high workload condition.

Using the battery alone as the power source does help to reduce the power loss. However, using the battery alone without the AC source reduces the available power to support events with high power demand. When using the battery as the only source, a thermal management module (e.g., a module based on a Dynamic Thermal Tuning (DTT) framework, Intel®, referred to as a DTT module hereinafter) for the CPU of the device will reduce the peak power that the CPU can draw, which translates to lower performance of the CPU and thus lower performance of the device. Today no battery charger exists that allows the battery operating as the primary power source and the AC source operating as the secondary power source.

According to the present application, both the above issues may be addressed by applying a reversal power supply mode of using the battery as the primary power source and the AC source as the secondary power source when the AC source and the battery are both available for providing power to the device. The performance comparison between the existing power supply solution and the proposed reversal power supply solution in the present application is shown in the following Table 1.

TABLE 1

| Method | Existing solution | Pros | Cons |
|---|---|---|---|
| 1 | AC (primary) + | Total available | High |
| | Battery (secondary) | power: AC + Battery | power loss |
| | | | in NVDC |
| 2 | Battery only | No power loss in | Limited |
| | | NVDC | available |
| | | | power |
| | Proposed solution | Pros | Cons |
| 3 | Battery (primary) + | Total available | |
| | AC (secondary) | power: Battery + AC | |
| | | Loss in NVDC only | |
| | | occurs when power | |
| | | demand exceeds | |
| | | battery capability | |

The proposed solution in the present application may become even more meaningful when more employees work from home instead of working on-site. The laptops are plugged into the wall most of the time giving merit to the proposed solution. Similarly, the proposed solution may be also applicable to power hungry gaming laptops which are usually used with the AC source plugged in.

Another problem is when to trigger the reversal power supply mode of using the battery as the primary power source and the AC source as the secondary power source. The present application describes a trigger mechanism which is to be deployed only when the performance of the device is limited. This can be realized using machine-learning methods such as Long Short-Term Memory (LSTM) recurrent neural network, support vector machine, random forest, etc. This intelligence will ensure charging is minimally impacted and not compromised when the battery operates as the primary power source.

It is to be noted that the proposed solution may be intelligently triggered and not get deployed when not required such as in low workload conditions where heat is not an issue for the device. For example, out of 8 operating hours, the power supply mode of using the battery as the primary power source and the AC source as the secondary power source might only get triggered for 30 minutes or so when heavy workloads occur and the temperature of the device starts to limit the performance of the device.

In addition, battery life and technology in recent years have also been improved, e.g. a battery life of more than 14 hours will be a standard for high-end laptop. Even if 50% of the battery capacity is charged, still 7 hours runtime is expected which is sufficient for many users. On the other hand, although the battery gets discharged when the proposed reversal power supply mode is triggered, the duration for applying the reversal power supply mode may be only temporary as the high workload in most applications may not persist over long periods of time. When the reversal power supply mode is disengaged, battery charging may resume.

Previous solutions may disconnect the AC source from the mobile device when the battery is in use for providing power to the device. Even though the AC source is connected and available for providing power to the device, it does not have any power contribution when the battery is in use. In these previous solutions, when the battery is selected as the preferred power source, the AC source is disconnected hence depriving the AC source to be used as a supplementary power source. Without the AC source as a secondary power source, the battery will be highly stressed with current spikes. In a device having a thermal management module (e.g. a DTT module), a combined power source (instead of a single source at a time) presented to the device will enable the thermal management module to set higher CPU power consumption limits.

In the present application, it is proposed to use the battery as the primary power source and use the AC source as the secondary power source under certain conditions even when the AC source and the battery are both available for supplying power to the device. This is different from the traditional system where the AC source always overrides the battery as the primary power source. By allowing a reverse primary role, the battery can be discharged even when the AC source is available. Since the battery becomes the primary power source, there may be less power dissipation loss as the power from the battery is accessible without the NVDC stage. This may reduce power loss thus enabling increased thermal margin for the device.

It should be noted that the total available power for the device in this reverse mode (the battery as the primary power source and the AC source as the secondary power source) is still a sum of power from the AC source and the battery. This is to be contrasted from purely switching from the AC source to the battery alone as the power source. In the latter case, the AC source is not available even though it is plugged in.

Thus the advantages or features of the proposed solution in the present application may include: improving battery health and hence safety of related products; low thermal dissipation in high workloads resulting in better performance of power-hungry devices such as gaming laptops; more power available from both the battery and the AC source because of lower power conversion loss; total available power being the sum of power from the battery and the AC source.

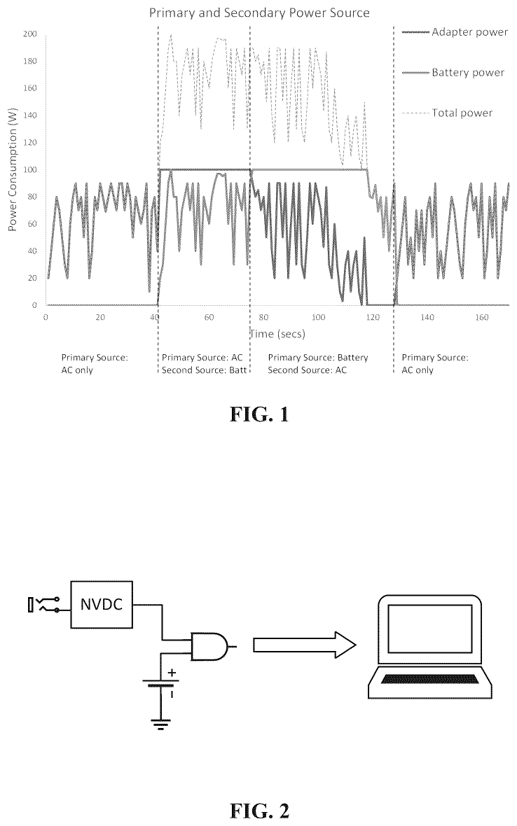

FIG. 1 shows example power consumptions under three modes of power supply configuration. There may be three modes of power supply configuration. The first mode is using the AC source as the only power source. The second mode is using the AC source as the primary power source and using the battery as the secondary power source. The third mode is the proposed reversal power supply mode of using the battery as the primary power source and the AC source as the secondary power source.

As shown in FIG. 1, in the time period of t=0 to t=40 secs: the AC source is the power source while the battery is not supplying any power; in the time period of t=40 secs to t=75 secs: the AC source is the primary power source while the battery supplements power as the secondary power source; in the time period of t=75 secs to t=120 secs: the battery is the primary power source while the AC source supplements power as the secondary power source; in the time period of t>125 secs: the AC source becomes the power source while the battery is not supplying any power. It is noted that the total power available in the time period of t=75 secs to t=120 secs is the sum of power from the AC source and the battery.

In other words, a switchable prioritized “AND” configuration of power sources is proposed according to some embodiments of the present application. In a traditional device with a NVDC stage, the AC Source is always the prioritized (primary) power source while the battery serves as a supplementary (secondary) power source. This is to be differentiated from an “OR” configuration where the battery may operate alone as the power source which suffers from power limitation and significantly discharging the battery.

In one aspect of the present application, with the switchable prioritized “AND” configuration, the reverse mode is allowed to happen (upon the battery meets minimum conditions). It is proposed that the battery may be the prioritized (primary) power source while the AC source may be a secondary power source acting in a supplementary mode. This is a novel role for the battery which has traditionally been a secondary power source when the AC source is available.

FIG. 2 shows an example “AND” configuration in which both a battery and an AC source are used to provide power to a laptop according to some embodiments of the present application. In the embodiments, it is proposed that the primary power source can be switchable from the AC source to the battery. It is to be noted that the symbol of the “AND” gate in FIG. 2 does not represent that a physical AND gate exists between the laptop and the power sources, but indicates that the total power available for the laptop may be the sum of power from the AC source and the battery.

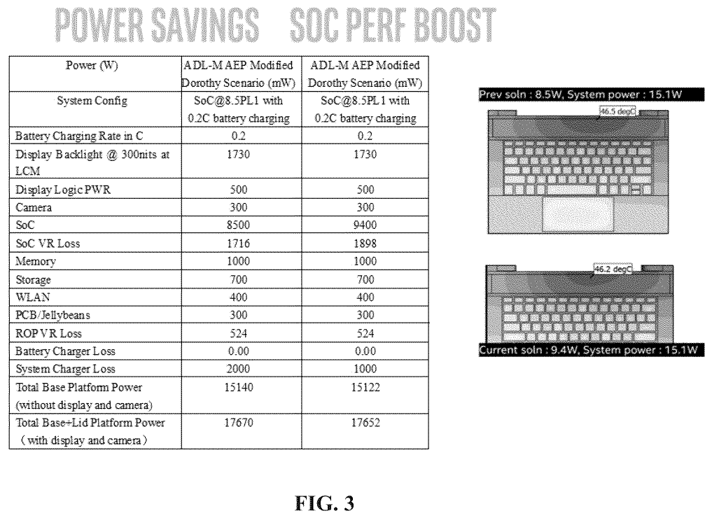

The benefit of saving power loss in the power supply mode of using the battery as the primary power source and the AC source as the secondary power source is shown in FIG. 3, which shows an example simulation result illustrating reduction in charger loss contributing to more power available to a System on Chip (SoC) with similar thermal performance (e.g. for a fanless system), according to some embodiments of the present application. In the table in the left part of FIG. 3, the first column shows various kinds of possible power consumption sources in a laptop, the second column shows the power consumptions corresponding to these possible power consumption sources under the conventional power supply mode (AC source as the primary source, battery as the secondary source), and the third column shows the power consumptions corresponding to these possible power consumption sources under the proposed power supply mode (battery as the primary source, AC source as the secondary source). As shown in FIG. 3, with the proposed power supply mode, the SoC can consume 9.4 W instead of 8.5 W while the system charger loss is reduced from 2 W to 1 W. The reduction in battery charger switching losses may translate to a higher performance of the laptop. The laptop maintains similar temperatures in both cases.

In another aspect of the present application, it is proposed that the role change should only occur when the battery-related and device-related conditions permit. The conditions triggering the role change are also a critical part of the present application. Two aspects of conditions may be involved in triggering the role change.

### Battery-Related Condition:

The reversal power supply mode of using the battery as the primary power source and the AC source as the secondary power source may be triggered at certain battery State-Of-Charge (SOC) where the expected battery degradation during the power supply mode is acceptable. For example, if battery chemistry consists of LiCoO₂ cathode and graphite anode which are commonly used in today's mobile devices, little or no degradation is expected after charge/discharge cycles when the battery charge limit is below 50%. In other words, the reversal power supply mode may be trigged when the SOC of the battery is higher than a predetermined SOC threshold (e.g. 50%).

In addition, the reversal power supply mode may be triggered when a predicted usage time of the laptop is within a predicted remaining battery runtime. For example, when the Meteor Lake platform achieves 14 hours runtime with full charge, 50% SOC still provides about 7 hours runtime which is sufficient to many users. Usage time prediction may be achieved by Artificial Intelligence learning the user behavior over time (e.g., Machine Learning, Deep Learning, etc.).

### Device-Related Condition:

From the perspective of the device, the reversal power supply mode may be triggered when the device is running high workloads (e.g. bursty or sustained). The workloads of the device may be predicted by a thermal management module of the device (e.g. the DTT module).

Furthermore, the reversal power supply mode may be triggered when a temperature of one or more parts of the device (e.g. CPU of the device) is above a predetermined threshold. The temperature of one or more parts of the device can be determined by the thermal management module of the device (e.g. the DTT module).

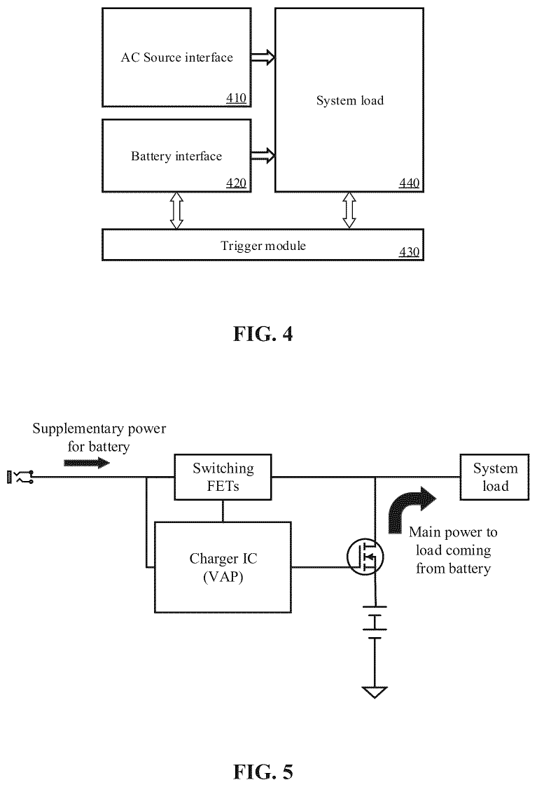

Summarizing the above described two aspects of the present application, according to some embodiments of the present application, as shown in FIG. 4, a device (e.g. laptop, tablet, mobile phone, etc.) may include an AC source interface 410 to be coupled to an AC source; a battery interface 420 to be coupled to a battery to be charged by the AC source and discharged for supplying power to the device; and a trigger module 430 to trigger a power supply mode for supplying power to system load 440 of the device based on a battery-related condition and a device-related condition. Here, the power supply mode may include a reversal power supply mode of using the battery as a primary power source for the device and using the AC source as a secondary power source for the device when the AC source and the battery are both available for providing power to the device. Of course, like the traditional system, the power supply mode may also include a normal power supply mode of using the AC source as the primary power source for the device and using the battery as the secondary power source for the device when the AC source and the battery are both available for providing power to the device.

The battery-related condition may include a SOC of the battery, a predicted remaining runtime of the battery, or a predicted remaining usage time of the device. Accordingly, the trigger module may trigger the reversal power supply mode when the SOC of the battery is higher than a predetermined SOC threshold or the predicted remaining usage time of the device is less than the predicted remaining runtime of the battery.

The device-related condition may include a predicted workload of the device or a temperature of one or more parts of the device. Accordingly, the trigger module may trigger the reversal power supply mode when the predicted workload of the device includes a bursty or sustained workload or the temperature of one or more parts of the device is above a predetermined threshold.

It is to be noted that the battery-related conditions and the device-related conditions may be considered in combination to determine a power supply mode preferred for the device. Thus a policy for determining the power supply mode for the device may be established based on the battery-related conditions and the device-related conditions. Table 2 shows an example policy to determine the power supply mode for the device. The numbers in Table 2 are given as examples and are subject to experimental adjustments. In the example, the CPU temperature is measured at the beginning of running the workload.

TABLE 2

| Device related | | | Battery related | | |
|---|---|---|---|---|---|
| conditions | | | conditions | | |
| | CPU Temp | | Battery | Predicted | Mode |
| | during | | SOC and | Remaining | Primary, |
| DTT predicted | initial | | remaining | Work-from- | Secondary |
| SOC_Workload | workload | | runtime | home hours | source |
| Sustained or | ≥40° | C. | ≥60% | 2 hours | Battery, AC |
| Bursty | | | (=8.4 hr) | | |
| Sustained or | <35° | C. | <55% | Don't care | Battery, AC |
| Bursty | | | (=7.7 hr) | | |
| Sustained or | <35° | C. | ≥60% | Don't care | Battery, AC |
| Bursty | | | (8.4 hr) | | |
| Sustained or | ≥40° | C. | <10% | Don't care | AC, Battery |

| | | | | |
|---|---|---|---|---|
| Bursty | | (=1.4 hr) | | |
| Idle or Semi | Don't care | Don't care | Don't care | AC, Battery |
| active | | | | |

As discussed above, the power supply mode for the device may be determined based on the battery-related and device-related conditions and triggered for the device to operate in the power supply mode. In other words, the primary power source and the secondary power source may be both used for the device and the roles of the power sources may be switchable and prioritized depending on the related conditions. Next, the details about implementing the proposed switchable prioritized “AND” configuration of power sources will be further described from perspectives of both hardware modification and software solution architecture.

Currently, prevailing battery charger Integrated Circuits (ICs) (e.g. from Texas Instruments, Renesas Electronics, etc.) can make the AC source as the primary power source and the battery as the secondary power source, and can also make the battery as the only power source. However, these charger ICs cannot make the battery as the primary power source and the AC source as the secondary power source.

According to some embodiments of the present application, it is proposed to modify a feature available in these charger IC which is called a Vmin Active Protection (VAP) feature. In the VAP feature, the AC source is assumed to be disconnected, and the device is running in the mode of using the battery as the only power source for the device. However, at the input path of the AC source, there is a capacitor that can store energy and be used in the VAP feature to supplement power for the device if the battery voltage drops below a certain threshold due to high current spikes. In this case, the battery is the primary power source (since the AC source is not connected) and the capacitor acts as the secondary power source. In the embodiments of the present application, by swapping the capacitor with the AC source as the secondary power source, the modified VAP feature can be used to implement the reversal power supply mode of using the battery as the primary power source and the AC source as the secondary power source.

FIG. 5 shows an example simplified block diagram of a power supply module for using a battery as a primary power source and using an AC source as a secondary power source to supply power to system load of a device, according to some embodiments of the present application. As shown in FIG. 5, a battery charger IC with the VAP feature can be used to implement the desired power supply mode. Specifically, when the trigger module is to trigger the reversal power supply mode, the battery charger IC may be controlled via the switching FETs to operate in a VAP-modified mode where the VAP feature is to be configured (i.e. modified) to implement the reversal power supply mode. In this case, the power for the system load of the device may mainly come from the battery, and the AC source acts as a supplementary power for the battery. Conversely, when the trigger module is to trigger the normal power supply mode, the battery charger IC may be controlled via the switching FETs to operate in a VAP-unmodified mode where the VAP feature is configured to implement the normal power supply mode.

In an embodiment of the present application, taking ISL9241 from Renesas Electronics as an example charger IC with the VAP feature, in order to implement the reversal power supply mode, when the charger IC operates in the VAP-modified mode, main modifications may include: allowing the VAP feature to work in an AC mode; disabling the On-the-Go mode in the VAP feature by software in the charger IC (the On-the-Go mode is used by the VAP feature to charge back the capacitor at the AC input end in the absence of the AC adapter); disabling output of a PROCHOT signal; and setting a threshold voltage to enable the AC adapter path to be near the battery voltage (e.g., 0.2V lower than the battery voltage).

In addition to the hardware modification, a detailed process for triggering the power supply mode will be described with reference to FIG. 6.

FIG. 6 shows an example software solution architecture for a device to implement a power supply mode determined based on an Adaptive Performance Policy, according to some embodiments of the present application. As shown in FIG. 6, the solution architecture may mainly involve a Power Delivery (PD) controller, an Embedded Controller (EC), a Basic Input Output System (BIOS), a battery charger IC, and a thermal management module (e.g. a DTT module based on a Dynamic Platform and Thermal Framework (DPTF), Intel®) in the device. The thermal management module may be the key component in the device to drive the decision of the power supply mode, which will drive the prioritization of power path connection to the device.

The detailed flow for determining and triggering a power supply mode for the device may be described as follows.

First, the EC may determine the availability of the AC/Type-C/USB-C source connection (e.g. via a PPS charger adaptor) and also determine the availability of the battery (e.g. the SOC of the battery is above a critical level). The EC may indicate the availability of the AC source and the battery to the BIOS (e.g. through an Opregion interface using a System Control Interrupt (SCI)). The BIOS may indicate the availability of the AC source and the battery to the thermal management module by updating Original Equipment Manufacturer (OEM) variables. If both the AC source and the battery are available, the thermal management module may load and execute an Adaptive Performance Policy established based on the battery-related conditions and the device-related conditions to determine the power supply mode.

Then the power supply mode may be set into Charger participant exposed by the BIOS. The Charger participant in BIOS may indicate if battery charging is to be enabled or disabled and indicate the power path to the device based on the battery-related conditions and the device-related conditions such as the battery state of charge, the workload of the device, and the CPU temperature. The Charger participant may store the configuration about the power path in BIOS and update the EC through the Opregion interface.

Next, the EC may read the configuration about the power path via the Opregion interface and send the configuration to the PD controller or the AC path to enable or disable the power path. The EC may also control the battery charger IC to be configured to implement the power supply mode as determined based on the battery-related conditions and the device-related conditions.

In an example, when a USB Type-C connector is used to connect a battery charger with the device, the USB Type-C connector software interface (USCI) specification may be applied between the EC and the BIOS, between the BIOS and Operation System (OS) drivers, and also between the OS drivers and the thermal management module.

From the above description, the BIOS of the device needs to satisfy mainly two requirements as follows. Firstly, the BIOS is required to expose the Charger participant such that the power supply mode can be set by the DTT module. Secondly, the BIOS is required to update the EC through the Opregion interface based on the power supply mode (e.g. shown in Table 3) received.

TABLE 3

| Power Supply Mode | Charging | Primary Power Source |
|---|---|---|
| 0 [Wall power path] | Enabled | AC source |
| 1 [Battery power path] | Disabled | Battery |

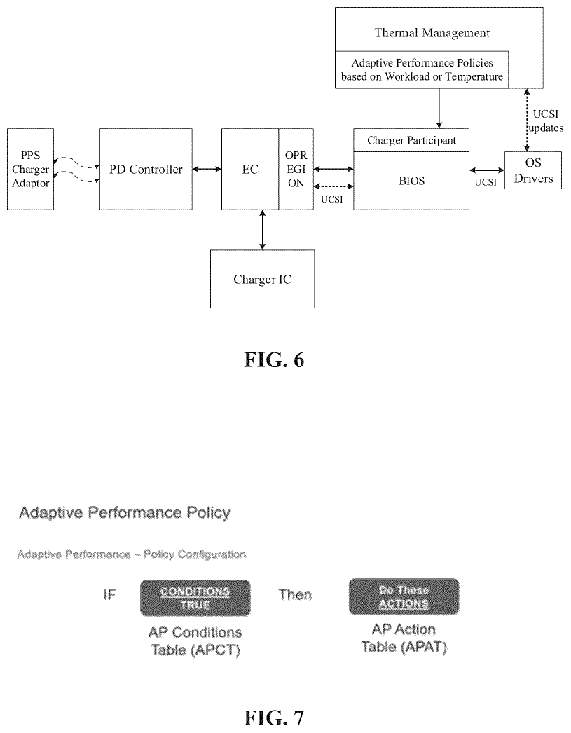

Furthermore, the thermal management module (e.g. DTT module) is the key component in the device to drive the decision of the power supply mode. Specifically, the DTT module may determine the power supply mode based on the workload of the device, the state-of-charge of the device, the CPU temperature or availability of wall power source connection. For example, the DTT module can load and execute an Adaptive Performance Policy established based on these variables to decide the power supply mode. FIG. 7 shows an example Adaptive Performance Policy configuration to determine a power supply mode for a device, according to some embodiments of the present application. As shown in FIG. 7, an Adaptive Performance Conditions Table (APCT) (e.g. the foregoing Table 2 herein) may be loaded and used to derive an Adaptive Performance Action Table (APAT) for determining the power supply mode for the device.

According to the above description about the hardware modification and software solution architecture for implementing the proposed solution of the present application, in some embodiments of the present application, the device may include a battery charger circuit with a VAP feature. When the reversal power supply mode is triggered, the VAP feature may be modified to implement the reversal power supply mode.

In some embodiments, the trigger module of the device may include a thermal management module of the device to determine the power supply mode for the device by executing an Adaptive Performance Policy established based on the battery-related condition and the device-related condition. The trigger module of the device may further include an EC and a BIOS of the device. The EC may determine availability of the AC source and the battery for the device, indicate the availability of the AC source and the battery to the BIOS, and control a battery charger circuit of the device to implement the power supply mode when the power supply mode is triggered. The BIOS may indicate the availability of the AC source and the battery to the thermal management module, and update configurations of the EC based on the power supply mode. The thermal management module may determine the power supply mode by executing the Adaptive Performance Policy when both the AC source and the battery is available, and set the power supply mode into Charger participant exposed by the BIOS.

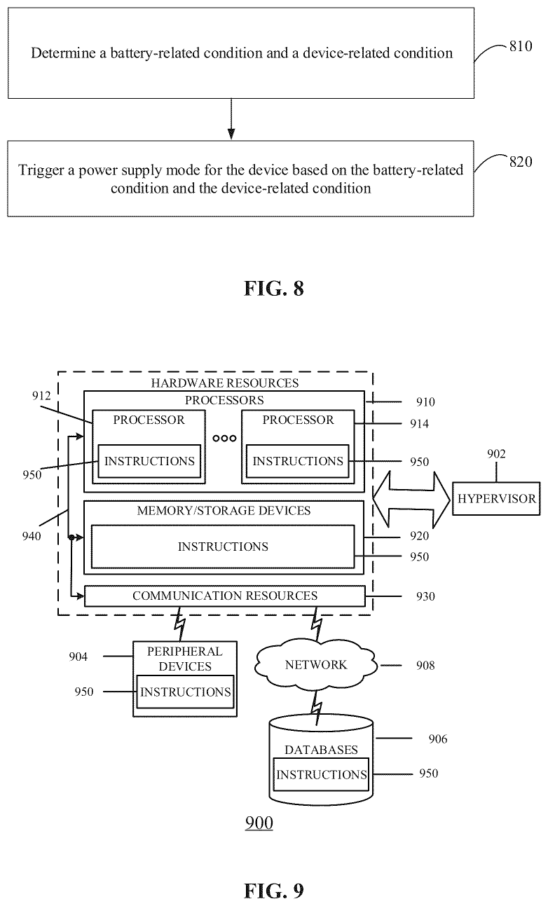

In addition to the above detailed description about the hardware and software configuration of the device, a flowchart of a proposed method for supplying power to the device will be briefly described below with referent to FIG. 8. As shown in FIG. 8, the method may include operations 810 and 820. The device may include an AC source interface to be coupled to an AC source and a battery interface to be coupled to a battery to be charged by the AC source and discharged for supplying power to the device.

At operation 810, the device may determine a battery-related condition and a device-related condition. The battery-related condition may include a State-Of-Charge (SOC) of the battery, a predicted remaining runtime of the battery, or a predicted remaining usage time of the device. The device-related condition may include a predicted workload of the device or a temperature of one or more parts of the device.

At operation 820, the device may trigger a power supply mode for the device based on the battery-related condition and the device-related condition. The power supply mode may include a reversal power supply mode of using the battery as a primary power source for the device and using the AC source as a secondary power source for the device when the AC source and the battery are both available for providing power to the device.

According to some embodiments, triggering the power supply mode based on the battery-related condition and the device-related condition may include triggering the reversal power supply mode when the SOC of the battery is higher than a predetermined SOC threshold or the predicted remaining usage time of the device is less than the predicted remaining runtime of the battery.

According to some embodiments, triggering the power supply mode based on the battery-related condition and the device-related condition may include triggering the reversal power supply mode when the predicted workload of the device includes a bursty or sustained workload or the temperature of one or more parts of the device is above a predetermined threshold.

According to some embodiments, the device may further include a battery charger circuit with a VAP feature, and triggering the power supply mode based on the battery-related condition and the device-related condition may include triggering the reversal power supply mode by controlling the battery charger circuit to operate in a VAP-modified mode where the VAP feature is to be modified to implement the reversal power supply mode.

According to some embodiments, the power supply mode may further include a normal power supply mode of using the AC source as the primary power source for the device and using the battery as the secondary power source for the device when the AC source and the battery are both available for providing power to the device, and triggering the power supply mode based on the battery-related condition and the device-related condition includes triggering the normal power supply mode by controlling the battery charger circuit to operate in a VAP-unmodified mode where the VAP feature normally operates to implement the normal power supply mode.

According to some embodiments, triggering the power supply mode based on the battery-related condition and the device-related condition may include determining the power supply mode for the device by executing an Adaptive Performance Policy established based on the battery-related condition and the device-related condition.

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 920 may include main memory, disk storage, or any suitable combination thereof. The memory/storage devices 920 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 930 may include interconnection or network interface components or other suitable devices to communicate with one or more peripheral devices 904 or one or more databases 906 via a network 908. For example, the communication resources 930 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

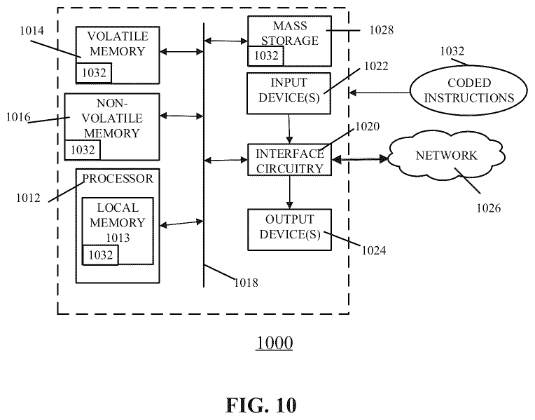

FIG. 10 is a block diagram of an example processor platform in accordance with some embodiments of the disclosure. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes interface circuitry 1020. The interface circuitry 1020 may be implemented by any type of interface standard, such as an Ethernet interface, a universal serial bus (USB), a Bluetooth® interface, a near field communication (NFC) interface, and/or a PCI express interface.

In the illustrated example, one or more input devices 1022 are connected to the interface circuitry 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 1020 of the illustrated example, thus, typically includes a graphics driver card, a graphics driver chip and/or a graphics driver processor.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1026. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, redundant array of independent disks (RAID) systems, and digital versatile disk (DVD) drives.

Machine executable instructions 1032 may be stored in the mass storage device 1028, in the volatile memory 1014, in the non-volatile memory 1016, and/or on a removable non-transitory computer readable storage medium such as a CD or DVD.

The following paragraphs describe examples of various embodiments.

Example 1 includes a device, including: an Alternating Current (AC) source interface coupled to an AC source; a battery interface coupled to a battery to be charged by the AC source and discharged for supplying power to the device; and a trigger module to trigger a power supply mode for the device based on a battery-related condition and a device-related condition, wherein the power supply mode includes a reversal power supply mode of using the battery as a primary power source for the device and using the AC source as a secondary power source for the device when the AC source and the battery are both available for providing power to the device.

Example 2 includes the device of Example 1, wherein the battery-related condition comprises a State-Of-Charge (SOC) of the battery, a predicted remaining runtime of the battery, or a predicted remaining usage time of the device.

Example 3 includes the device of Example 1 or 2, wherein the trigger module is to trigger the reversal power supply mode when the SOC of the battery is higher than a predetermined SOC threshold or the predicted remaining usage time of the device is less than the predicted remaining runtime of the battery.

Example 4 includes the device of any of Examples 1 to 3, wherein the device-related condition comprises a predicted workload of the device or a temperature of one or more parts of the device.

Example 5 includes the device of any of Examples 1 to 4, wherein the trigger module is to trigger the reversal power supply mode when the predicted workload of the device comprises a bursty or sustained workload or the temperature of one or more parts of the device is above a predetermined threshold.

Example 6 includes the device of any of Examples 1 to 5, further comprising a battery charger circuit with a Vmin Active Protection (VAP) feature, wherein the trigger module is to trigger the reversal power supply mode by controlling the battery charger circuit to operate in a VAP-modified mode where the VAP feature is configured to implement the reversal power supply mode.

Example 7 includes the device of any of Examples 1 to 6, wherein the trigger module comprises a thermal management module of the device to determine the power supply mode for the device by executing an Adaptive Performance Policy established based on the battery-related condition and the device-related condition.

Example 8 includes the device of any of Examples 1 to 7, wherein the trigger module further comprises an Embedded Controller (EC) and a Basic Input Output System (BIOS) of the device, wherein the EC is to determine availability of the AC source and the battery to the device, indicate the availability of the AC source and the battery to the BIOS, and control a battery charger circuit of the device to implement the power supply mode when the power supply mode is triggered; the BIOS is to indicate the availability of the AC source and the battery to the thermal management module, and update configurations of the EC based on the power supply mode; and the thermal management module is to determine the power supply mode by executing the Adaptive Performance Policy when both the AC source and the battery is available, and set the power supply mode into Charger participant exposed by the BIOS.

Example 9 includes the device of any of Examples 1 to 8, wherein the power supply mode further comprises a normal power supply mode of using the AC source as the primary power source for the device and using the battery as the secondary power source for the device when the AC source and the battery are both available for providing power to the device, and the trigger module is to trigger the normal power supply mode by controlling the battery charger circuit to operate in a VAP-unmodified mode where the VAP feature is configured to implement the normal power supply mode.

Example 10 includes the device of any of Examples 1 to 9, wherein the battery is built in the device or detachable to the device.

Example 11 includes the device of any of Examples 1 to 10, wherein in the VAP-modified mode, the battery charger circuit is configured to enable the VAP feature to work in an AC mode.

Example 12 includes the device of any of Examples 1 to 11, wherein in the VAP-modified mode, the battery charger circuit is configured to disable an On-the-Go mode in the VAP feature.

Example 13 includes the device of any of Examples 1 to 12, wherein in the VAP-modified mode, the battery charger circuit is configured to disable output of a PROCHOT signal.

Example 14 includes the device of any of Examples 1 to 13, wherein in the VAP-modified mode, the battery charger circuit is configured to set a threshold voltage to enable an AC adapter path to be near a voltage of the battery, for example, a predetermined value (e.g., 0.2V) lower than the voltage of the battery.

Example 15 includes a method for supplying power to a device, the device comprising an Alternating Current (AC) source interface coupled to an AC source and a battery interface coupled to a battery to be charged by the AC source and discharged for supplying power to the device, wherein the method comprises: determining a battery-related condition and a device-related condition; and triggering a power supply mode for the device based on the battery-related condition and the device-related condition, wherein the power supply mode includes a reversal power supply mode of using the battery as a primary power source for the device and using the AC source as a secondary power source for the device when the AC source and the battery are both available for providing power to the device.

Example 16 includes the method of Example 15, wherein the battery-related condition comprises a State-Of-Charge (SOC) of the battery, a predicted remaining runtime of the battery, or a predicted remaining usage time of the device.

Example 17 includes the method of Example 15 or 16, wherein triggering the power supply mode based on the battery-related condition and the device-related condition comprises triggering the reversal power supply mode when the SOC of the battery is higher than a predetermined SOC threshold or the predicted remaining usage time of the device is less than the predicted remaining runtime of the battery.

Example 18 includes the method of any of Examples 15 to 17, wherein the device-related condition comprises a predicted workload of the device or a temperature of one or more parts of the device.

Example 19 includes the method of any of Examples 15 to 18, wherein triggering the power supply mode based on the battery-related condition and the device-related condition comprises triggering the reversal power supply mode when the predicted workload of the device comprises a bursty or sustained workload or the temperature of one or more parts of the device is above a predetermined threshold.

Example 20 includes the method of any of Examples 15 to 19, wherein the device further comprises a battery charger circuit with a Vmin Active Protection (VAP) feature, and triggering the power supply mode based on the battery-related condition and the device-related condition comprises triggering the reversal power supply mode by controlling the battery charger circuit to operate in a VAP-modified mode where the VAP feature is configured to implement the reversal power supply mode.

Example 21 includes the method of any of Examples 15 to 20, wherein triggering the power supply mode based on the battery-related condition and the device-related condition comprises determining the power supply mode for the device by executing an Adaptive Performance Policy established based on the battery-related condition and the device-related condition.

Example 22 includes the method of any of Examples 15 to 21, wherein the power supply mode further comprises a normal power supply mode of using the AC source as the primary power source for the device and using the battery as the secondary power source for the device when the AC source and the battery are both available for providing power to the device, and triggering the power supply mode based on the battery-related condition and the device-related condition comprises triggering the normal power supply mode by controlling the battery charger circuit to operate in a VAP-unmodified mode where the VAP feature is configured to implement the normal power supply mode.

Example 23 includes the method of any of Examples 15 to 22, wherein in the VAP-modified mode, the battery charger circuit is configured to enable the VAP feature to work in an AC mode.

Example 24 includes the method of any of Examples 15 to 23, wherein in the VAP-modified mode, the battery charger circuit is configured to disable an On-the-Go mode in the VAP feature.

Example 25 includes the method of any of Examples 15 to 24, wherein in the VAP-modified mode, the battery charger circuit is configured to disable output of a PROCHOT signal.

Example 26 includes the method of any of Examples 15 to 25, wherein in the VAP-modified mode, the battery charger circuit is configured to set a threshold voltage to enable an AC adapter path to be near a voltage of the battery, for example, a predetermined value (e.g., 0.2V) lower than the voltage of the battery.

Example 27 includes a computer readable medium storing computer program instructions thereon, wherein the computer program instructions, when executed by a processor, implement the method of any of Examples 15 to 26.

Example 28 includes an apparatus comprising a memory storing computer program instructions and a processor coupled to the memory, wherein the processor is configured to execute the computer program instructions to implement the method of any of Examples 15 to 26.

Embodiments according to the disclosure are in particular disclosed in the attached claims directed to a method and a device, wherein any feature mentioned in one claim category, e.g., method, can be claimed in another claim category, e.g., device, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Any term expressed in plural form that does not expressly state “plurality” or “multiple” similarly refers to a quantity equal to or greater than one. The terms “group,” “set”, “subset,” and the like refer to a quantity equal to or greater than one. The words “exemplary” and “example” are used herein to mean “serving as an example, instance, demonstration, or illustration”. Any aspect, embodiment, or design described herein as “exemplary” or “example” is not necessarily to be construed as preferred or advantageous over other aspects, embodiments, or designs.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of . . . ” with regard to a group of elements may be used herein to mean at least one element from the group consisting of the elements.

Conditional language, such as, among others, “can” or “may”, unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
an Alternating Current (AC) source interface to be coupled to an AC source;
a battery interface to be coupled to a battery to be charged by the AC source and discharged for supplying power to the device; and
a trigger module to trigger a power supply mode for the device based on a battery-related condition and a device-related condition,
wherein the power supply mode includes a reversal power supply mode of using the battery as a primary power source for the device and using the AC source as a secondary power source for the device when the AC source and the battery are both available for providing power to the device.

2. The device of claim 1, wherein the battery-related condition comprises a State-Of-Charge (SOC) of the battery, a predicted remaining runtime of the battery, or a predicted remaining usage time of the device.

3. The device of claim 2, wherein the trigger module is to trigger the reversal power supply mode when the SOC of the battery is higher than a predetermined SOC threshold or the predicted remaining usage time of the device is less than the predicted remaining runtime of the battery.

4. The device of claim 1, wherein the device-related condition comprises a predicted workload of the device or a temperature of one or more parts of the device.

5. The device of claim 4, wherein the trigger module is to trigger the reversal power supply mode when the predicted workload of the device comprises a bursty or sustained workload or the temperature of one or more parts of the device is above a predetermined threshold.

6. The device of claim 1, further comprising a battery charger circuit with a Vmin Active Protection (VAP) feature, wherein the trigger module is to trigger the reversal power supply mode by controlling the battery charger circuit to operate in a VAP-modified mode where the VAP feature is configured to implement the reversal power supply mode.

7. The device of claim 1, wherein the trigger module comprises a thermal management module of the device to determine the power supply mode for the device by executing an Adaptive Performance Policy established based on the battery-related condition and the device-related condition.

8. The device of claim 7, wherein the trigger module further comprises an Embedded Controller (EC) and a Basic Input Output System (BIOS) of the device,
the EC is to determine availability of the AC source and the battery to the device, indicate the availability of the AC source and the battery to the BIOS, and control a battery charger circuit of the device to implement the power supply mode when the power supply mode is triggered;
the BIOS is to indicate the availability of the AC source and the battery to the thermal management module, and update configurations of the EC based on the power supply mode; and
the thermal management module is to determine the power supply mode by executing the Adaptive Performance Policy when both the AC source and the battery is available, and set the power supply mode into Charger participant exposed by the BIOS.

9. The device of claim 6, wherein the power supply mode further comprises a normal power supply mode of using the AC source as the primary power source for the device and using the battery as the secondary power source for the device when the AC source and the battery are both available for providing power to the device, and
the trigger module is to trigger the normal power supply mode by controlling the battery charger circuit to operate in a VAP-unmodified mode where the VAP feature is configured to implement the normal power supply mode.

10. The device of claim 1, wherein the battery is built in the device or detachable to the device.

11. A method for supplying power to a device, the device comprising an Alternating Current (AC) source interface to be coupled to an AC source and a battery interface to be coupled to a battery to be charged by the AC source and discharged for supplying power to the device, wherein the method comprises:
determining a battery-related condition and a device-related condition; and
triggering a power supply mode for the device based on the battery-related condition and the device-related condition,
wherein the power supply mode includes a reversal power supply mode of using the battery as a primary power source for the device and using the AC source as a secondary power source for the device when the AC source and the battery are both available for providing power to the device.

12. The method of claim 11, wherein the battery-related condition comprises a State-Of-Charge (SOC) of the battery, a predicted remaining runtime of the battery, or a predicted remaining usage time of the device.

13. The method of claim 12, wherein triggering the power supply mode based on the battery-related condition and the device-related condition comprises triggering the reversal power supply mode when the SOC of the battery is higher than a predetermined SOC threshold or the predicted remaining usage time of the device is less than the predicted remaining runtime of the battery.

14. The method of claim 11, wherein the device-related condition comprises a predicted workload of the device or a temperature of one or more parts of the device.

15. The method of claim 14, wherein triggering the power supply mode based on the battery-related condition and the device-related condition comprises triggering the reversal power supply mode when the predicted workload of the device comprises a bursty or sustained workload or the temperature of one or more parts of the device is above a predetermined threshold.

16. The method of claim 11, wherein the device further comprises a battery charger circuit with a Vmin Active Protection (VAP) feature, and triggering the power supply mode based on the battery-related condition and the device-related condition comprises triggering the reversal power supply mode by controlling the battery charger circuit to operate in a VAP-modified mode where the VAP feature is configured to implement the reversal power supply mode.

17. The method of claim 11, wherein triggering the power supply mode based on the battery-related condition and the device-related condition comprises determining the power supply mode for the device by executing an Adaptive Performance Policy established based on the battery-related condition and the device-related condition.

18. The method of claim 16, wherein the power supply mode further comprises a normal power supply mode of using the AC source as the primary power source for the device and using the battery as the secondary power source for the device when the AC source and the battery are both available for providing power to the device, and
triggering the power supply mode based on the battery-related condition and the device-related condition comprises triggering the normal power supply mode by controlling the battery charger circuit to operate in a VAP-unmodified mode where the VAP feature is configured to implement the normal power supply mode.

19. A non-transitory computer readable medium storing computer program instructions thereon, wherein the computer program instructions, when executed by a processor, implement the method of claim 11.

20. An apparatus comprising a memory storing computer program instructions and a processor coupled to the memory, wherein the processor is configured to execute the computer program instructions to implement the method of claim 11.
